(19) United States
(12) Patent Application Publication
(10) Pub. No.: US 2024/0242732 A1
(43) Pub. Date: Jul. 18, 2024

(54) SYSTEM AND METHOD FOR DETERMINING A USERS EMOTIONS AND INCREASING THE USERS EMOTIONAL INTELLIGENCE AND SELF-AWARENESS UTILIZING THE USERS VOICE SAMPLES

(71) Applicants: Kristine Holt, Santa Clara, UT (US); R. Scott Evans, Victoria (CA)

(72) Inventors: Kristine Holt, Santa Clara, UT (US); R. Scott Evans, Victoria (CA)

(21) Appl. No.: 18/415,375

(22) Filed: Jan. 17, 2024

Related U.S. Application Data
(60) Provisional application No. 63/480,253, filed on Jan. 17, 2023.

(51) Int. Cl. G10L 25/63

(52) U.S. Cl. CPC G10L 25/63

(57) ABSTRACT

A method for determining a user's emotions and increasing the user's emotional intelligence and self-awareness includes providing user specific information (e.g., age, gender, location) through an intake form on a device via a software interface, such as an application (app) on a smartphone, recording via the app an audio file of the user's voice engaging in a predetermined task such as a countdown, using the audio file to extract emotional markers predictive of the user's emotional states, and recommending one or more actions or prescriptions to the user to improve the user's emotional intelligence and well-being. The method may further include providing journaling entries in response to survey prompts, analyzing the journaling entries using natural language processing, and generating emotional scores predictive of the user's emotional states.

### CROSS-REFERENCE TO RELATED APPLICATIONS

This application claims the benefit of U.S. Provisional Application Ser. No. 63/480,253, filed on Jan. 17, 2023, which is incorporated herein by reference.

### TECHNICAL FIELD

The present disclosure relates generally to systems and methods for measuring emotional states. More particularly, the disclosed systems and methods are embodied in software that compares and analyzes voice samples and provides a user with tools, insights, and monitoring to increase emotional intelligence and general well-being.

### BACKGROUND

In a recent meta-analysis published in the Harvard Business Review, it is reported that a review of ten separate investigations involving an estimated 5,000 participants determined that only 10-15% of individuals meet the basic requisites of healthy internal and external self-awareness. Eurich, T. (2023, January 18). What self-awareness really is (and how to cultivate it). Harvard Business Review. The overarching insight of this study is that most people lack the tools and methods that would enable self-awareness, which is a barrier to developing strategies for overall wellness.

It is within this general context that any tools or methods that enable self-awareness offer the opportunity for individuals to step outside of their fettered perception of the world and better understand how they are impacted by situations, context, and actions. Conventionally, the measurement of emotional states and emotional intelligence relies on survey instruments, be they self-administered, or administered by a wellness professional (e.g., psychologist, counselor, etc.). The plethora of survey batteries promoted by the psychology establishment, designed to capture many emotional dimensions, is a testament of how important emotional measurement is to wellness. Understanding one's emotional states is often the first step in understanding how to address wellness.

Generally speaking, emotional intelligence, in this context, describes the ability, capacity, skill, or self-perceived ability to identify, assess, and manage the emotions of oneself. People who possess a high degree of emotional intelligence know themselves better than those that do not and can often more effectively sense and understand the feelings of others. People with higher emotional intelligence are generally more pleasant, resilient, and optimistic. And, by extension, these people score higher on measures of wellness. It is in the context of self-awareness and the critical relationship of emotional understanding to wellness that an improved system and method of measuring emotional states becomes a valuable asset in an individual's efforts to manage and ameliorate their emotional intelligence and wellness. Another important development is the ubiquitous internet and the ability to access digital tools that are not bounded by time nor space. The plethora of device options ensures that the majority of individuals in Western society can access and engage with online tools via the internet. Similarly, cloud enablement and responsive design means that online tools can offer a wide array of interactive functions and services. The use of smart devices to collect and monitor data about wellness is increasing the ability and interest in the broader consumer population and has made the adoption of these new technological innovations easier than ever before. Hence, there is a need for a tool that is not inherently limited to subjective measurement or temporal strictures and can passively and easily measure emotional states across time. Such a tool could further satisfy the need to provide a user with ongoing insights into the evolving nature of the conscious and unconscious emotions impacting their wellness. Accordingly, the systems and methods of the present disclosure aid a user in improving emotional intelligence, providing them with the self-awareness and related tools to identify, assess, and manage their own emotions and well-being.

### SUMMARY OF EXAMPLE EMBODIMENTS

In some embodiments, a method for determining a user's emotions and increasing the user's emotional intelligence and self-awareness comprises a user passively, or through a structured instrument, providing user specific information (e.g., age, gender, location) through an intake form on a user device via a user interface on an app; recording via the app an audio file of the user's voice engaging in a predetermined task; transferring the audio file and other data from the user device to an audio processing platform via an application programming interface; extracting measures of the user's emotional states from the audio file; and recommending one or more actions or prescriptions to the user based on a current emotional state determined by the user.

In some embodiments, extracting measures of the user's emotional states from the audio file may further comprise extracting combinations of spectral features from the audio file recorded on the user device, creating audio arrays based on the combinations of spectral features, scoring a probability of emotional states by applying predictive algorithms to the audio array, and reporting the probability of emotional states to the user.

In some embodiments, a method for determining a user's emotions and increasing the user's emotional intelligence and self-awareness comprises a user providing user data (e.g., audio files, feedback, and journaling) via an app in response to survey prompts, processing the user data via a cloud AI solution, analyzing unstructured or structured user generated feedback or commentary using natural language processing, extracting topical patterns, generating measurement signal amplifiers (i.e., weighting coefficients) and updateable features using the topical patterns, modifying predictive algorithms based on the measurement signal amplifiers and updateable features, generating emotional likelihoods of the user, transforming the emotional likelihoods of the user into standardized forms of emotional scores, and tracking the standardized forms of the emotional scores on the app sequentially across time. In some embodiments, the process further comprises a cloud architecture storing the voice samples and user data in a secure cloud database and generating user reports, ongoing user tracking, and model updating based on the emotional likelihoods of the user and the standardized forms of the emotional scores.

In some embodiments, a method for determining a user's emotions and increasing the user's emotional intelligence and self-awareness comprises a user providing journaling entries in response to survey prompts, describing aspects of their experiences, including, but not limited to, perceptions of emotional states, factors influencing emotions, behaviors or responses impacting emotional management, or any related observations that provide the user with an ongoing account of a wellness plan, completing an action response survey, analyzing user information provided via the journaling entries and the action response survey using natural language processing, and optimizing predictive algorithms used to generate estimates of emotional states and recommended actions. The method may further comprise evaluating the journaling entries and the action response survey through topic extraction, enhancing scoring depth (i.e., additional nuances or dimensions of currently measured emotional states), identifying training data outcomes for currently unmeasured emotional states that can be used to develop new machine learning derived predictive algorithms, and contributing emotional management insights to expand and elaborate strategies that prove to be effective.

In some embodiments, a method for determining a user's emotions and increasing the user's emotional intelligence and self-awareness comprises analyzing user data provided by the user, updating machine learning (AI) responsible for determining emotional scoring, and expanding effective self-management strategies adapted to specific cohorts of users.

### BRIEF DESCRIPTION OF THE DRAWINGS

The foregoing and other objects, aspects, features, and advantages of the present disclosure will become more apparent and better understood by referring to the following description taken in conjunction with the accompanying drawings in which:

FIG. 1 illustrates a flow chart of a first step detailing a sequence of user inputs and data transformations in a method for determining a user's emotions and increasing the user's emotional intelligence and self-awareness;

FIG. 2 illustrates a flow chart of a second step detailing a sequence of user inputs and data transformations in a method for determining a user's emotions and increasing the user's emotional intelligence and self-awareness;

FIG. 3 illustrates a flow chart detailing a sequence of user inputs and data transformations to derive emotional markers in a method for determining a user's emotions and increasing the user's emotional intelligence and self-awareness;

FIG. 4 illustrates a flow chart detailing a sequence of user inputs and data transformations in a method for determining a user's emotions and increasing the user's emotional intelligence and self-awareness;

FIG. 5 illustrates user feedback on the accuracy of a method for determining a user's emotions and increasing the user's emotional intelligence and self-awareness (referred to as “Vibeonix” in the drawings) in reflecting a user's experience of stress in the moment;

FIG. 6 illustrates user feedback on the accuracy of a method for determining a user's emotions and increasing the user's emotional intelligence and self-awareness in reflecting emotions in the moment;

FIG. 7 illustrates user feedback on the accuracy of a method for determining a user's emotions and increasing the user's emotional intelligence and self-awareness in reflecting a user's mindset in the moment;

FIG. 8 illustrates user feedback on the overall accuracy of a method for determining a user's emotions and increasing the user's emotional intelligence and self-awareness;

FIG. 9 illustrates user feedback on how helpful a method for determining a user's emotions and increasing the user's emotional intelligence and self-awareness was in heightening a user's self-awareness;

FIG. 10 illustrates user feedback on how helpful a method for determining a user's emotions and increasing the user's emotional intelligence and self-awareness was in heightening emotional intelligence;

FIG. 11 illustrates user feedback on the helpfulness of a method for determining a user's emotions and increasing the user's emotional intelligence and self-awareness as a self-reflection tool;

FIG. 12 illustrates a graph showing an average accuracy measure by session for a method for determining a user's emotions and increasing the user's emotional intelligence and self-awareness;

FIG. 13 illustrates a graph showing an average accuracy measure by user for a method for determining a user's emotions and increasing the user's emotional intelligence and self-awareness;

FIG. 14 illustrates a table showing a statistical analysis between a measured state and a user's perception of accuracy of a method for determining a user's emotions and increasing the user's emotional intelligence and self-awareness; and

FIG. 15 illustrates a table showing a statistical analysis, with Bonferroni adjustment, between a measured state and a user's perception of accuracy of a method for determining a user's emotions and increasing the user's emotional intelligence and self-awareness.

### DETAILED DESCRIPTION OF EXAMPLE EMBODIMENTS

The following descriptions depict only example embodiments and are not to be considered limiting in scope. Any reference herein to “the invention” is not intended to restrict or limit the invention to exact features or steps of any one or more of the exemplary embodiments disclosed in the present specification. References to “one embodiment,” “an embodiment,” “various embodiments,” and the like, may indicate that the embodiment(s) so described may include a particular feature, structure, or characteristic, but not every embodiment necessarily includes the particular feature, structure, or characteristic. Further, repeated use of the phrase “in one embodiment,” or “in an embodiment,” do not necessarily refer to the same embodiment, although they may.

Reference to the drawings is done throughout the disclosure using various numbers. The numbers used are for the convenience of the drafter only and the absence of numbers in an apparent sequence should not be considered limiting and does not imply that additional parts of that particular embodiment exist. Numbering patterns from one embodiment to the other need not imply that each embodiment has similar parts, although it may.

Accordingly, the particular arrangements disclosed are meant to be illustrative only and not limiting as to the scope of the invention, which is to be given the full breadth of the appended claims and any and all equivalents thereof. Although specific terms are employed herein, they are used in a generic and descriptive sense only and not for purposes of limitation. Unless otherwise expressly defined herein, such terms are intended to be given their broad, ordinary, and customary meaning not inconsistent with that applicable in the relevant industry and without restriction to any specific embodiment hereinafter described. As used herein, the article “a” is intended to include one or more items. When used herein to join a list of items, the term “or” denotes at least one of the items, but does not exclude a plurality of items of the list. For exemplary methods or processes, the sequence and/or arrangement of steps described herein are illustrative and not restrictive.

It should be understood that the steps of any such processes or methods are not limited to being carried out in any particular sequence, arrangement, or with any particular graphics or interface. Indeed, the steps of the disclosed processes or methods generally may be carried out in various sequences and arrangements while still falling within the scope of the present invention.

The term “coupled” may mean that two or more elements are in direct physical contact. However, “coupled” may also mean that two or more elements are not in direct contact with each other, but yet still cooperate or interact with each other.

The terms “comprising,” “including,” “having,” and the like, as used with respect to embodiments, are synonymous, and are generally intended as “open” terms (e.g., the term “including” should be interpreted as “including, but not limited to,” the term “having” should be interpreted as “having at least,” the term “includes” should be interpreted as “includes, but is not limited to,” etc.).

As previously discussed, there is a need for a system and method for analyzing sequential emotional states of a user, and thereafter reporting useful information on the user's emotions that can be instrumental in affecting positive change or ameliorating wellness. The methods and systems disclosed herein can also be used to develop and improve emotional intelligence by capturing information such as voice audio samples, feedback, journaling, and other useful qualitative information on multiple occasions to identify emotional markers and provide an ongoing sequential well-being assessment for the user. The ongoing sequential well-being assessment provides a timeline for measurement and feedback that can be tracked by the user as a composite well-being score.

It will be appreciated that the results of the systems and methods disclosed herein, among other things, further provide the user with an emotional state report and recommended actions. The user can use this temporally specific information for enhanced self-awareness by assisting the user in understanding the interaction of both their conscious and unconscious emotional states, and insights into personalized wellness strategies that correspond to the emotional states at the time of recording an audio file. A deeper understanding of one's unconscious emotional states also provides indicators for tuning predictive algorithms across time for a range of emotional states.

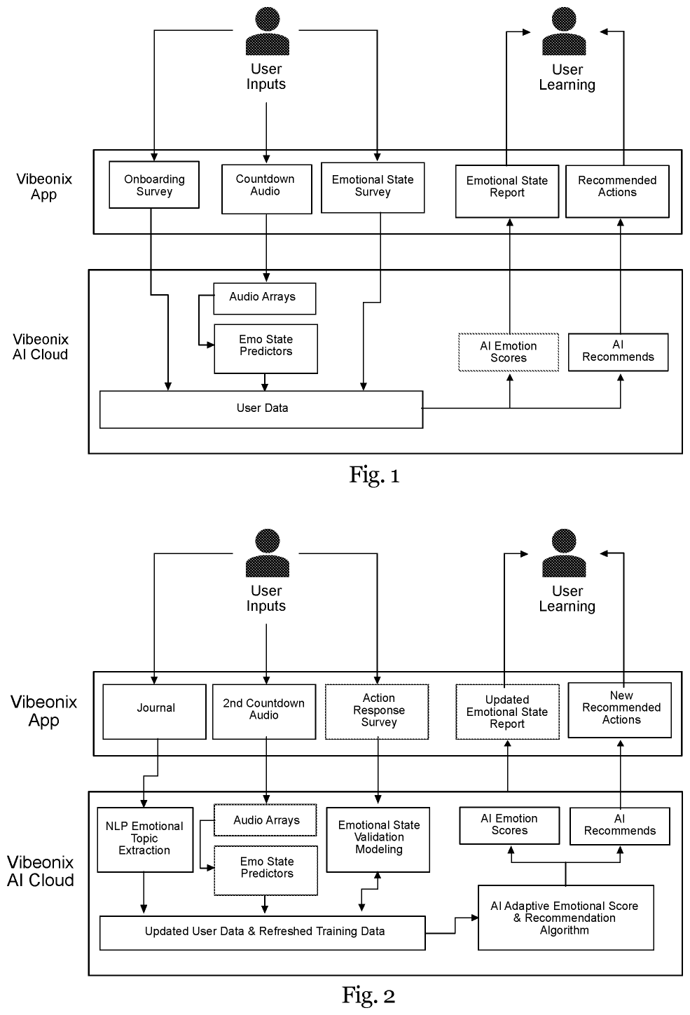

In some embodiments, as shown in FIG. 1, a method for determining a user's emotions and increasing the user's emotional intelligence and self-awareness comprises a user passively, or through a structured instrument, providing user specific information (e.g., age, gender, location) through an onboarding survey and emotional self-assessments data through an emotional state survey, each inputted on a user device via a user interface on an app. The app may be in communication with a microphone on the user device whereby the user records an audio file of the user's voice engaging in a predetermined task. The predetermined task may comprise a countdown wherein the user counts out loud into the microphone for 90 seconds to establish an emotional baseline. The audio file may be saved as, or converted into, a waveform audio file format, MP3, AAC, FLAC, or other alternative audio file format. The audio file is then transferred from the user device to an audio processing platform via an application programming interface (API).

Next, the API extracts measures of the user's emotional states from the audio file. For example, measures of the user's emotional states may comprise combinations of spectral features that are used to create audio arrays. Based on threshold values, the audio arrays are converted into emotional markers, also referred to in the drawings as emotional state predictors, that are scored by probability according to predictive algorithms. An emotional state report and one or more recommended actions or prescriptions are then sent to the user via the app based on a current emotional state determined by the user in consultation with the emotional state report. It will be appreciated that both the emotional state report and the one or more recommended actions (hardcoded) assist the user in understanding the interaction of both his or her conscious and unconscious emotional states, as well as develop a corresponding wellness strategy.

The onboarding survey, as outlined above, may comprise asking one or more questions at a beginning of a session to establish a user's self-reported, conscious emotional states:
(1) “How are you feeling: thriving, okay, or struggling?”
(2) “What is on your mind today: relationships, money, work, school, friends, health, family, or others?”

While the one or more questions of the onboarding survey may be presented across a range of formats with varying answers, it will be appreciated that the results of a first question, as demonstrated above, indicate the user's self-reported, conscious emotional states. The user's self-reported, conscious emotional states may later be compared against unconscious emotional states recorded by passive measurement to improve awareness of one's emotional intelligence and generate personalized wellness strategies. Additionally, non-audio data, such as responses to the onboarding survey, can inform or enhance passive measurement and contribute to training ongoing machine learning for the predictive algorithms.

Next, the user records an audio file of the user's voice engaging in a predetermined task. In some embodiments, the predetermined task comprises the user counting out loud into a microphone for 90 seconds (a “countdown”), wherein the audio file may be saved or converted into a waveform audio file format. It will be appreciated, however, that the countdown may be performed for more or less than 90 seconds, comprise counting forwards or backwards from a starting number, or otherwise include other simple recitation tasks of numbers or words. In some embodiments, for example, the user may record a modified audio element or a truncated version of the countdown, lessening a user burden with input compliance and reducing the time required to record and upload the audio file. In some embodiments, the method further includes obtaining alternative or adapted audio information from the user as an augmentation or substitution for the countdown. Alternative or adapted audio information likewise reduces the user burden associated with the time and effort required to generate the audio file.

Speaking functionally, a purpose of the countdown is to establish an emotional baseline. An emotional baseline is a state one returns to after experiencing momentary or sustained emotional arousal. The emotional baseline may be determined utilizing longitudinal audio countdown data, as evidenced by continuous measurement, wherein a longer countdown creates a homeostatic pattern.

In a next step, the method comprises extracting emotional markers from the audio file of the countdown. Fluctuations in emotional markers emerge within time slices of the countdown, but the homeostatic pattern will remain. This enables the capture of signal variability, which reflects the actual emotional states surfacing in the audio file. Relative neutral emotional states are captured as an average of the time slices, where emotional markers are identified as signal variance. This process of identifying variability is further enhanced by looking at emotional changes across time using multiple measurement events and determining the relative neutral emotional states across time. Averaging emotional scores predictive of emotional states across time provides an additional relative baseline for the user, outside of a technical variability within a single event of the countdown. In some embodiments, extracting emotional markers from the audio file may further comprise extracting combinations of spectral features from the audio file recorded on the user device, creating audio arrays based on the combinations of spectral features, and scoring a probability of emotional states by applying predictive algorithms to the audio arrays.

The countdown has little arousal given the minimal emotional nature of counting. This enables the contrast between fluctuations in emotional markers and the homeostatic pattern inherent in the countdown. The countdown can be considered a less emotional act, unlike instances where individuals recite words or phrases. Furthermore, the countdown is not attached to specific emotional responses; therefore, the emotions detected during the 90 seconds can be regarded as significant artifacts representing intrinsic emotional states that are not biased by data collection. The temporal and situational nature of this measurement means that an original emotional score or an averaging of emotional scores can be used as the user's emotional baseline captured within the countdown homeostasis with variance swings capturing intrinsic emotional states of the user based on emotional markers. If the user later undergoes an emotional event, for example, an argument with a spouse, resulting measures will reflect a discernible variance from the emotional baseline of a significant magnitude that is not reflected in a less emotional context.

In some embodiments, the emotional markers extracted from the audio file comprise the following dimensions: positive energy emotion, negative energy emotion, love, peace, happiness, awareness, confidence, motivation, stress, anger, confusion, sadness, fear, loneliness, fear of losing identity, fear of separation, fear of loss of autonomy, fear of failure, fear of physical harm, and the stress response of fight, flight, and freeze.

In some embodiments, emotional markers are aggregated into mapping emotional score distributions with hypotheses tested on emotional score thresholds and their correlation to emotional states. Said embodiments permit a straightforward classification of emotional states based on emotional score thresholds. The emotional score thresholds then contribute to an understanding of how to aggregate and appropriately weight emotional markers, particularly when reporting either summarized or aggregate findings. A first iteration transformation of emotional markers, for example, may use a simple conversion of emotional scores to a 0-100 range.

In some embodiments, emotional markers are transformed into binary states to be used as training data for machine learning within the predictive algorithms. Testing uses a variety of thresholds and distributional properties for determining raw emotional score dichotomization, with the goal being to develop a predictive probability that is more effective at determining a binary state. The predictive probability replaces the simple conversion of emotional markers and instead permits using a more stable and computationally efficient method of scoring emotional markers from the audio file and capturing magnitudes of emotional markers.

In some embodiments, scoring of emotional markers uses a conversion formula: >80%=1 and <80%=0 to move from a predicted ratio state back to a binary state that expresses an implicit magnitude. The scoring of emotional markers is determined from an imputation or prediction process that is between zero and one, indicating a probability of a high emotional score. The conversion formula provides a more effective way of predicting the emotional score. An actual conversion formula for each emotional marker will vary depending on iteratively derived, most effective dichotomization parameters.

In some embodiments, interpretive simplification comprises demarcating emotional marker predictions into multiple categories. Cut-offs may differ for each emotional marker, aggregation, or composite score. For example, in some embodiments, a formula for simple conversion categorization may include:

Increment Value=Average value−minimum value/3 (1)

Maximum value−increment value/3 for equal parts (2)

Total value=Maximum value−minimum value (3)

Summarizing wellness involves a multitude of emotional markers used to create a composite score that determines a degree to which a user is “struggling,” is “okay,” or is “thriving.” The composite score, also called the well-being score, is based on an additive formula that uses the overall positive emotional marker, negative emotional marker, emotional valence, and emotional control score. It will be appreciated that several techniques may be used selectively for different measures: for example, simple conversion, arbitrary thresholds for categorization, and binary coding. In particular, binary coding may be used with machine learning and results in a probability of a binary selection. The probability of a binary selection, in turn, is a basis from which a final form of the well-being score can be transformed from a probability to an integer with a specified range.

While negative and positive markers summarize a large set of specific emotions, valence and control measure magnitude of expression and emotional management, respectively.

In some embodiments, the well-being score is divided into three states: struggling, okay, and thriving. The cut-offs between the three states are based on the distributional qualities of the final well-being score and may be continuously evaluated for cohort and measurement enhancement. For example, the cut-offs may be hard coded or determined by percentiles or standard deviations based on accumulated data or a specific cohort. This enables an ongoing effort to improve categorization into meaningful states that benefit the user. For example, as new cohorts are introduced, a continual learning process introduces adapted predictive algorithms and self-management repertoires that may effectively align with needs or characteristics of the specific cohort (e.g., veterans, millennials, late teens, seniors, healthcare professionals, etc.). It will be appreciated that measurements of emotional states and ongoing development of corresponding action or intervention repertoires may be adapted to designated cohorts, thereby enhancing the personalization of both measurements and recommended actions.

An interpretive power of cut-off adjustments derived from cohort and data updating is reflected in combinations of positive-negative difference, valence, and control that can be contextualized. For example, the emotional response to a situation such as a divorce can indicate thriving while scoring high on valence, high on control, and an overall positive difference; conversely, that same user is struggling if they experience low valence, low control, and high overall negative. In other non-situational instances, a user that experiences low valence, low control, and high positive difference over time would have a baseline of okay.

The formula considers how these scales or emotional scores might change across time. Adapting cut-offs for dichotomization for cohorts and modifying emotional baselines ensures that scoring and classification become increasingly personalized and less biased by dominant groups.

In some embodiments, scoring and measuring emotional markers for training data comprises classifying emotional scores as a “yes” if the original raw emotional score exceeds the 80th percentile and a “no” if the emotional score is below the 80th percentile. However, given raw distributions of the emotional markers, there are often other percentile cut-offs, which are more appropriate to the unique distribution of a marker. For example, raw, highly positive skews require special treatment. Platykurtic or leptokurtic distributions can rely on a broader range of percentile cut-offs. The determination of cut-offs for each emotional marker is determined by each model's confusion matrix and the extent to which the cut-offs can contribute to higher recall, precision, and area under the curve (AUC) metrics.

Once each of the emotional scores is classified as either a “yes” or “no” for exhibiting the emotional state, a predictive algorithm is developed to effectively predict “yes” and “no” for an individual based on the inputs of their audio file. The prediction is in the form of a probability of someone being classified as a “yes” (i.e., exhibiting signs of the characteristic being measured).

It will be appreciated that the system and method described herein has the flexibility of determining the threshold that defines “yes” or using the probability as a final form of the emotional score measuring the degree to which someone exhibits the emotional state being measured. For example, a threshold could be a 65% probability equals a “yes” to revealing evidence of a characteristic or condition. Alternatively, the probability can be used as a proxy for the magnitude of exhibiting a state or characteristic. For example, for the state of “happy,” with a threshold of 65%, an emotional score of 75% (0.75) means someone is classified as happy. Or, 75% indicates the degree to which someone is exhibiting signs of being happy.

The advantage of a binary-to-probability approach is that the predictive algorithm's success can be easily assessed, and the resulting probability can be converted to a standardized form of the emotional score for all measures. Unlike the raw form of the emotional scores with different ranges that cannot be compared (e.g., −10 to 125, or 0 to 20), the probability is a standardized form of the emotional score that can be easily compared (i.e., ranging between 0 and 1). The same probability can be easily converted into more accessible emotional scores for users to consume (e.g., 0-5 or 0-10, etc.).

For example,
1. EMO3 original range is 0-80
2. EMO1 original range is 0-1.31
3. EMO3 new predicted emotional score is 0-1, e.g., 0.65 (statistical interpretation—65% likely to be exhibiting EMO3)
4. EMO1 new predicted emotional score is 0-1 e.g., 0.42, (statistical interpretation—42% likely to be showing EMO1)

It will be appreciated that the emotional markers provide ingredients for the well-being score that provides both a generalized overview of a user's emotional intelligence and a simple method of tracking overall amelioration of emotional intelligence across time (i.e., by tracking self-reported assessments and passive measurement of emotional states). The well-being score assists users in understanding the interaction of both their self-aware emotions and unconscious emotional states and how to take this holistic emotional report into account in developing a corresponding wellness strategy. It is important to note that the goal is self-awareness of emotional states in combination with recommended action strategies. This offers users a path to wellness. It is still incumbent on the user to act in a manner that more effectively manages their wellness. But, within the content of this system, they are provided with tools to both monitor and manage their wellness.

After the emotional scores are generated, the app provides an emotional state report to the user summarizing the emotional states experienced by the user, as indicated from the well-being score and cut-off thresholds. The emotional state report may also comprise an emotional management score that indicates a multi-axis understanding of the user's control within a given emotion. Observing the patterns of variance among the emotional management score and other metrics allows the user to develop a deeper understanding of why the user feels what he or she feels. Through this understanding, the user can respond differently to external stimuli to experience a different emotional reaction. The present disclosure fills gaps in the market by providing an effective method of assisting the user to understand his or her emotional intelligence, self-awareness, and embark on more effective self-management and regulation.

Additionally, one or more recommended actions or prescriptions are provided to the user in order to improve emotional intelligence and overall well-being. The one or more recommended actions or prescriptions may comprise completing a written or auditory journal entry on a particular topic, conducting a self-assessment of the user's behaviours or attitudes, reinforcing relationships with others, or similar task to improve overall well-being. It will be appreciated that through repeated sessions, the user receives updated emotional state reports and new recommended actions based on ongoing tracking capabilities that capture individualised baselines, evolving situations and fluctuations in emotional states across time.

In some embodiments, a method for determining a user's emotions and increasing the user's emotional intelligence and self-awareness comprises a user survey evaluating ongoing measurement effectiveness by asking the user the following questions at an end of a session:
(1) “After self-reflection, I feel my well-being results are,” then the user rates from 0-5 accuracy.

(2) “I feel I am managing my emotions . . . ” then the user rates from 0-5 not well to very well.

Responses to the questions in the user survey may be used to verify the accuracy of the emotional scores shown in the emotional state report and thereafter be incorporated within the predictive algorithms as data to improve generation of the emotional scores in the future.

The user survey provides another validation loop and provides a framework for supervised learning. Until recent years, research in the emotional wellness area has almost exclusively cantered on the roles of intrapersonal emotion regulation and how individual responses to stress, challenges, or emotional distress affect a person's well-being. In contrast, it will be appreciated that interpersonal emotion regulation focuses on how emotions are regulated through others without one's own efforts to elicit that regulation.

In some embodiments, user specific information (e.g., age, gender, location) is used to personalize unique feedback question sets that are oriented to a specific emotional profile of the user. These questions may comprise structured scale-based responses, designed to inform a personalized emotional management strategy. The additional information is used to update the wellness assessments for each user, which continually adapt to changing emotional patterns and an anticipated emotional teleology of the user.

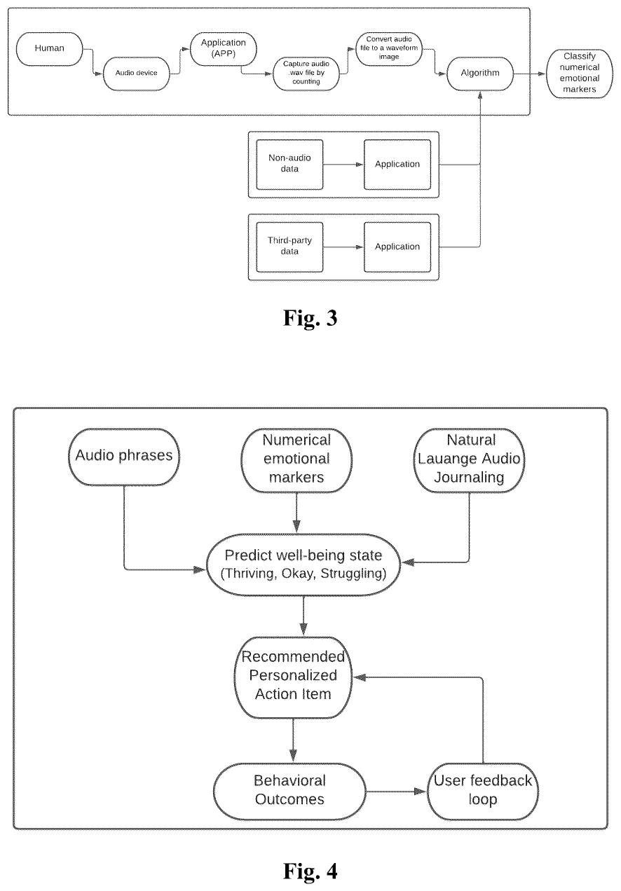

In some embodiments, as shown in FIGS. 2-3, a method for determining a user's emotions and increasing the user's emotional intelligence and self-awareness further comprises a user providing journaling entries in response to survey prompts; for example, describing aspects of their experiences, including, but not limited to, perceptions of emotional states, factors influencing emotions, behaviors or responses impacting emotional management, or any related observations that provide the user with an ongoing account of a wellness plan; completing an action response survey; analyzing user information provided via the journaling and the action response survey using natural language processing; and optimizing predictive algorithms used to generate estimates of emotional states and recommended actions. The method may further comprise evaluating the journaling and the action response survey through topic extraction (such as by using natural language processing (NLP)), enhancing scoring depth (i.e., additional nuances or dimensions of currently measured emotional states), identifying training data outcomes for currently unmeasured emotional states that can be used to develop new machine learning derived predictive algorithms, and contributing emotional management insights to expand and elaborate strategies that prove to be effective.

The user may input journaling entries directly into the app via a keyboard on the user device or through uploading handwritten samples via a camera on the user device. Optical character recognition software may electronically convert an image of the handwritten sample into machine-encoded text that is readable by a natural language processing modelling engine. The natural language processing modelling engine may be capable of identifying 40 to 50 situational and emotional topics, also referred to as topical patterns, within the journaling entries. The situational and emotional topics are then combined with emotional markers derived from the audio file to determine the final form of the emotional scores and well-being score, indicative of emotional states experienced by the user. It will be appreciated that the journaling entries provide an additional metric, alongside the audio file, to help validate the emotional scores and the well-being score used to generate an updated emotional state report.

Similarly, the action response survey provides another validation loop and framework for supervised learning and includes a training data pipeline used to update the predictive algorithms which may comprise emotion and recommendation algorithms. The data from the action response survey provides an intermediary validation step that extracts emotional markers from conscious, self-aware elements like the action response survey. The user may then adopt previously prescribed recommended actions and incorporate additional emotional components or non-recommended actions or behaviors into the wellness plan for that user. Continued sessions using the app, including subsequent countdowns, journaling entries, and action response surveys, generate a learning loop pulling form a larger set of data. Incorporating the learning loop into a personalized process increases the predictive algorithm's effectiveness at prescribing recommended actions that improve the user's emotional intelligence over time.

It will be appreciated that a quality and an individualization of recommended actions will evolve as user data captures the extent to which a set of users adopt and implement recommended actions. For example, a larger set of users and more historical user data contributes to an evolving personalized emotional scoring that captures and instantiates magnitudes and changes across time of a wider range of emotional states. Likewise, as the set of users increases, a predictive power of the predictive algorithm increases to identify ongoing relationships between emotion measurements, recommended actions, and how these contribute in turn to perceived emotional intelligence and overall well-being.

It will be appreciated that user inputs, including countdowns, onboarding surveys, emotional state surveys, journaling entries, and action responses may vary in composition and sequence of administration. However, the predictive algorithm may still apply adaptive learning to analyze emotional markers, generate emotional state reports, and provide one or more recommended actions to the user, regardless of the inclusion or exclusion of any user input in the overall modeling process.

As shown in FIG. 4, in some embodiments, a method for determining a user's emotions and increasing the user's emotional intelligence and self-awareness comprises 1) a user providing recorded audio phrases, numerical emotional markers determined from surveys, and natural language audio journaling, 2) classifying the emotional markers into states of well-being (i.e., thriving, okay, struggling), 3) providing recommended personalized action items for improving behavioral outcomes, and 4) integrating a feedback loop to enhance and augment the recommended personalized action items. For example, based on response rates and survey evidence from a set of users regarding an effectiveness of the recommended personalized action items, some recommended personalized action items with low response rates or survey evidence indicating low effectiveness may be downregulated in frequency while other recommended personalized action items with high response rates or survey evidence indicating high effectiveness may be upregulated in frequency.

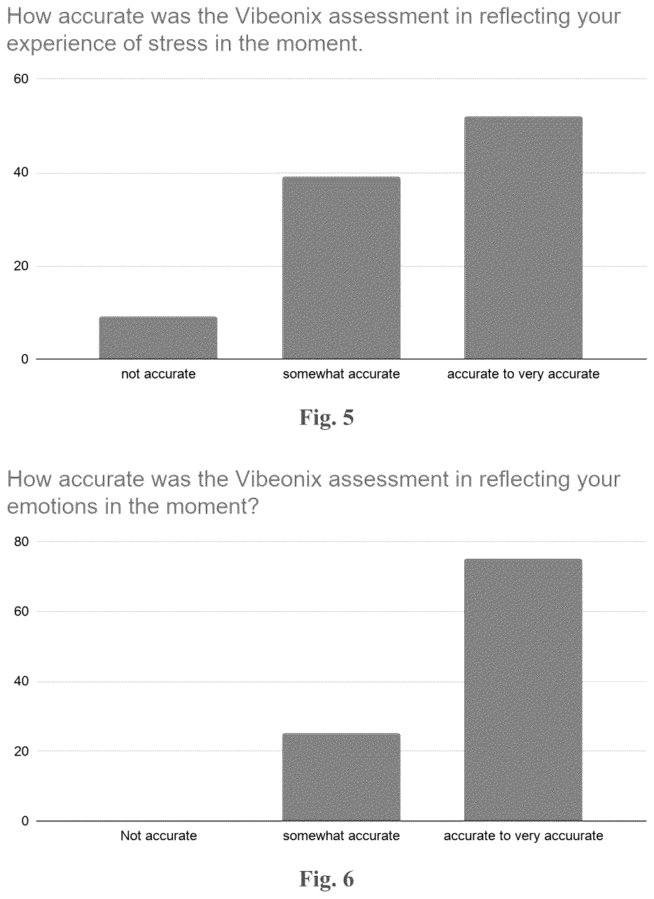

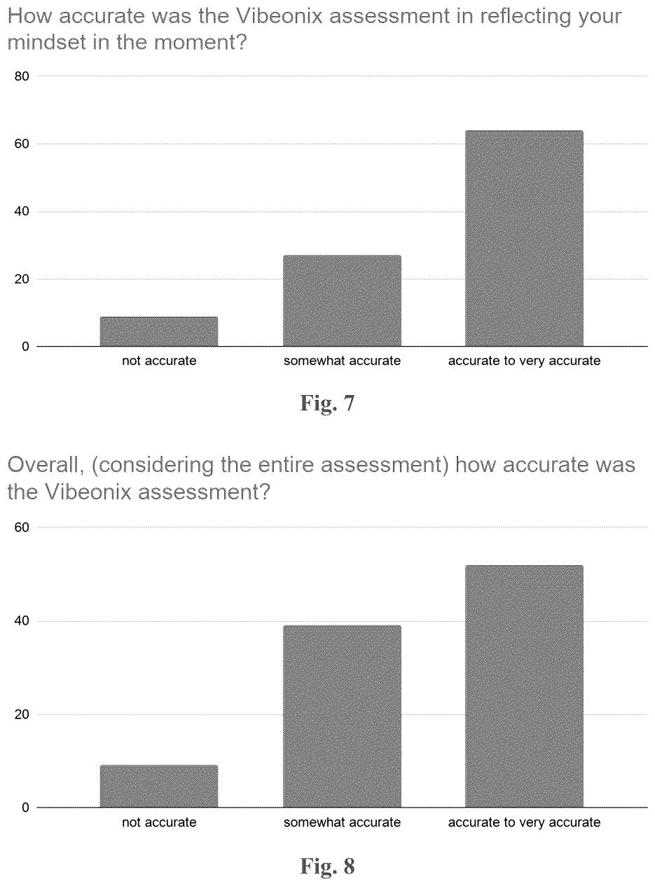

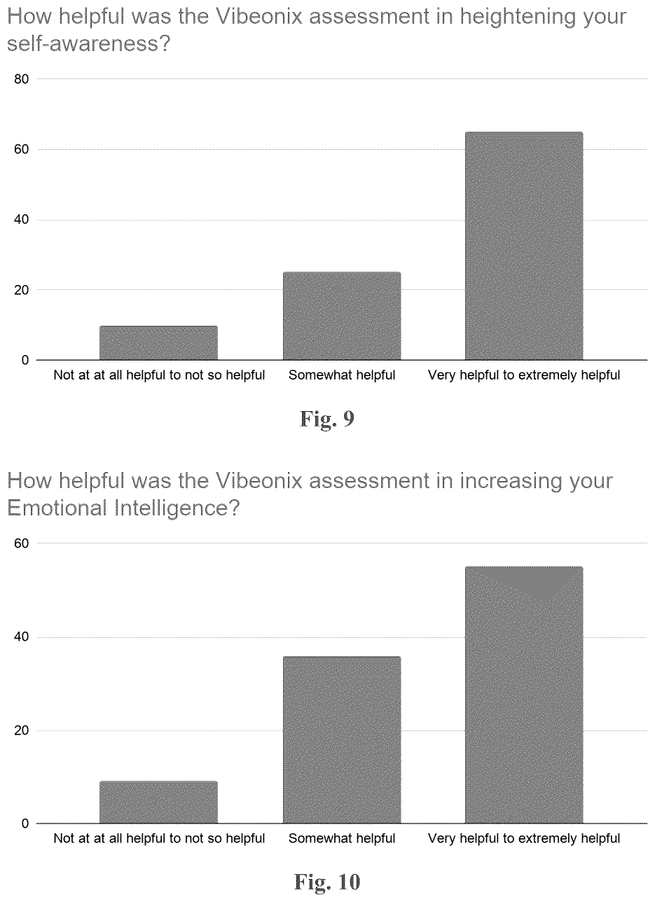

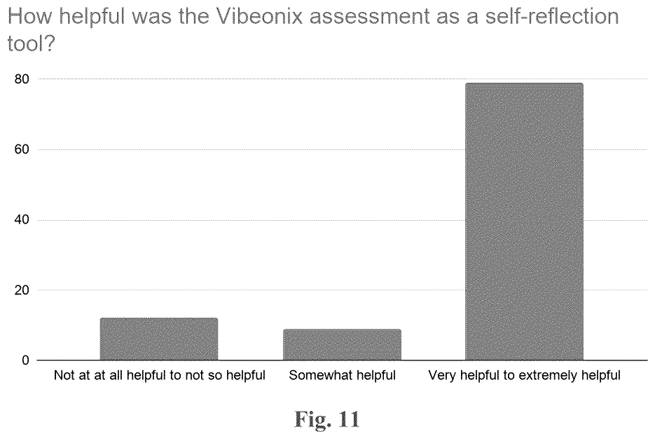

FIGS. 5-15 illustrate data from one or more studies, representing results of the method for determining a user's emotions and increasing the user's emotional intelligence and self-awareness.

The method for determining a user's emotions and increasing the user's emotional intelligence and self-awareness described herein, referred to in FIGS. 1-2 and 5-11 as Vibeonix, has initially been validated by a research study designed to evaluate: 1) a relationship between self-reported emotional states and emotional markers; and 2) a perceived value or helpfulness of the system that can impact how users understand emotional intelligence.

Supporting evidence on the system's impact on measurement, self-awareness, and self-management is based, in part, on user feedback which addresses the following questions as it pertains to the systems and methods of the present disclosure:
(1) Does the tool measure emotional states that the user can validate?
(2) Does the tool give the user insights into emotional states that are not easily obtained without the technology?
(3) Does the tool provide tools for assisting self-management of emotional states?

User feedback was obtained from both a formal study launched at an initial release of the system and ongoing feedback from users providing a secondary understanding of the effectiveness of the system. For the initial research, an independent principal investigator (Connie Watson, Ed.D.) implemented the initial evaluation of the system (referred to as Vibeonix). The evaluation methodology is based on a quasi-qualitative design, using a small convenience sample representing several key cohorts (e.g., age, sex). The response rate is 66% based on a general invitation sent to 50 individuals associated with the researcher.

Participants received an email with login details to access their accounts in a web portal. Once accessed, the participants registered and uploaded a voice assessment. Recording the voice assessment using their device microphone, participants counted 1 to 100. Results of the voice assessment were reported to the participants in an app and covered four areas (i.e., emotion, stress response, mindset, and attitude). Participants were then asked to review the results on the app and attend one of two online focus groups.

The two online focus groups included an application overview and a general explanation of the results. At an end of the focus group discussion, a survey link was sent to each user, and each user was asked to take a 10-item survey while they were still in the focus group. Participants provided demographic information and responses to a 10-item evaluation survey: 1) How accurate was the Vibeonix assessment in reflecting your emotions in the moment? (7-point scale); 2) How accurate was the Vibeonix assessment in reflecting your experience of stress in the moment? (7-point scale); 3) How accurate was the Vibeonix assessment in reflecting your attitudes in the moment? (7-point scale); 4) How accurate was the Vibeonix assessment in reflecting your mindset in the moment? (7-point scale); 5) Overall, (considering the entire assessment) how accurate was the Vibeonix assessment? (5-point scale); 6) How helpful was the Vibeonix assessment in heightening your self-awareness? (5-point scale) 7) How helpful was the Vibeonix assessment in increasing your Emotional Intelligence? (5-point scale) 8) How helpful was the Vibeonix assessment as a self-reflection tool? (5-point scale) 9) How likely are you to continue to use Vibeonix over the next year? 10) How likely is it that you would recommend Vibeonix to a friend or colleague? (7-point scale)

A participant demographic profile ranged from 22-48 years, with 58% percent of participants being female.

As shown in FIGS. 5-11, a sample of users reported the following responses to the following questions:

Does the Tool Measure Emotional States that the User can Validate? (User Feedback)
78% reported that Vibeonix accurately reflects emotions in the moment
67% reported that Vibeonix accurately reflects stress in the moment
64% reported that Vibeonix accurately reflects attitudes in the moment
88% reported that Vibeonix accurately reflects mindset in the moment
73% reported that Vibeonix accurately reflects overall assessment
   Does it Give the User Insights into Emotional States that are not Easily Ascertained without the Technology? (User Feedback)
67% reported that Vibeonix was very to extremely helpful in heightening self-awareness
55% reported that Vibeonix was very to extremely helpful in increasing emotional intelligence

### Does it Provide Tools for Assisting Self-Management of Emotional States? (User Feedback)

58% reported that Vibeonix was very to extremely helpful as a self-reflection tool
42% are likely to very likely to recommend the Vibeonix tool to a friend or colleague
55% are likely to very likely to use the Vibeonix tool in the future

Vibeonix provides a feedback loop that enables beta users of the app to indicate the degree to which the app is providing measures of emotional states that align with a self-perceived or self-assessed emotional state. While one of the objectives of Vibeonix is to generate awareness of unconscious or latent emotional states, the relationship between a passively measured state and how this measurement aligns with a conscious awareness of an emotional state does provide an indication of how effectively Vibeonix's methodology is measuring actual emotional states, be they conscious or unconscious.

The following provides an evaluation methodology, wherein the convenience sample was selected with some effort to have a gender and age mix:
a) Median female age: 43.5
b) Median male age: 30
c) Number of unique female users: 31
d) Number of unique male users: 48
e) Median age for all users: 42.5
f) Three users did not provide age information, all users provided gender.
There are a total of 79 unique users, who contributed validation feedback.
3 of the 79 had 10+ repetitions (repeated measures).
Excluding the 3 outliers, the average number of repetitions is 1.6 measures per user.
There are a total of 170 validation measures in the sample, where each validation measure represents an independent user session.
The raw data contains all of the passive measurement vectors and the user question on accuracy.

The following provides a more detailed description of the evaluation methodology:
Users on the app are asked, to answer a question following the app response to data input;
Following the input of the countdown audio and the app measurement response, users are asked, on a scale of 0-5, to indicate the extent to which their measured emotional state corresponds to their perceived emotional state.
“After self-reflection, I feel my well-being results are not accurate to accurate (rate 1-5).
“I feel I am managing my emotions not well to very well (rate 1-5).

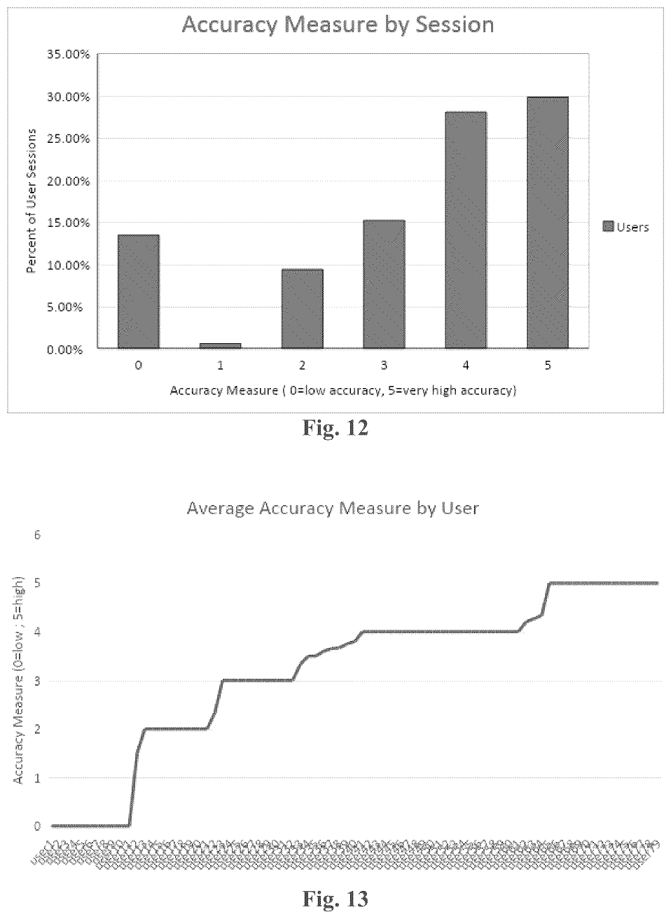

FIG. 12 shows additional evidence of the high degree to which users indicate that Vibeonix's emotional states reflects the emotional state perceived by the user. The graph reflects a validation of the accuracy reported by users on a session-by-session basis. Of note, most users provided validation measures for each session independently of prior or subsequent sessions.

Given many users provided accuracy feedback for multiple sessions, FIG. 13 shows the average accuracy measure for each user. The pattern for the average session accuracy by user below supports a similar conclusion evident in the breakdown of accuracy measures by session in the preceding figure. The Vibeonix passive measurement of emotional states is perceived as accurate (emotional score=3+) in a majority of sessions and among a majority of users.

The descriptive view of the accuracy measure shown in FIG. 13 suggests that passive measurement used in a method for determining a user's emotions and increasing the user's emotional intelligence and self-awareness aligns with perceived emotional states. Moreover, further tests were conducted to eliminate the possibility that accuracy measures were distorted by the measured state creating a bias in perceived accuracy. In practice, eliminating the bias in perceived accuracy meant contrasting the difference in well-being as measured by a method for determining a user's emotions and increasing the user's emotional intelligence and self-awareness (i.e., struggling, neutral, thriving) and the accuracy of the method as perceived by the user.

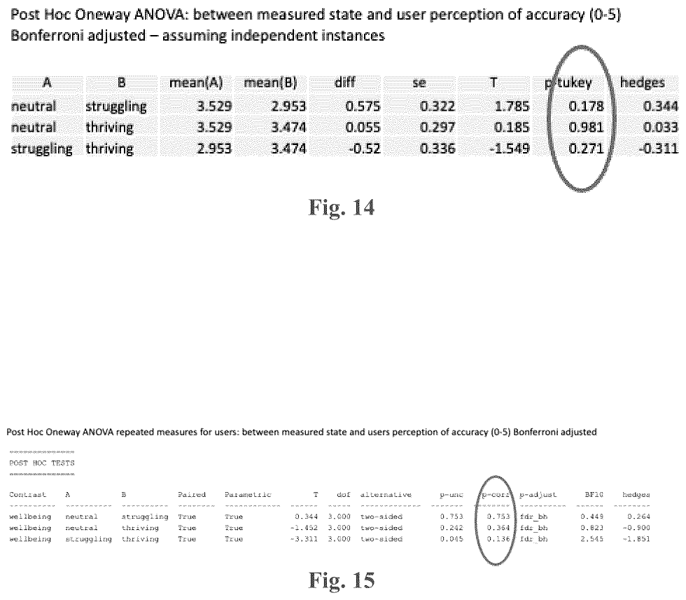

As shown in FIGS. 14-15, two tests were created, wherein the first assumes session independence and the second treats users with multiple sessions as a repeated measure design. Both the tests use an adjusted post hoc test within a one-way analysis of variance (ANOVA). Without assuming session independence, the use of tests designed for repeated measures, there is a similar outcome: there is not an apparent effect of the measured state on accuracy scores.

The basic descriptive view of accuracy broken down by user and session indicates the measured state employed in a method for determining a user's emotions and increasing the user's emotional intelligence and self-awareness is providing most users with a measure or classification that aligns with their perception of their own well-being. Moreover, there is no indication to suggest that the emotional state of the user impacts their perception of this alignment or accuracy and that the passive measurement of the user is relatively effective regardless of their perceived well-being.

While the evaluation discussed above provides an initial baseline for the validity of the emotional markers and the emotional scores and a perceived utility by users of the method to generate valuable insights and help manage emotional states, additional feedback from current users indicates ongoing positive assessment of the tool. Currently, 73% of registered users have reported that the emotional scores provided by the method are accurate to very accurate.

The aforementioned discussion of the research results provides validation for measurement and the degree to which scores align user perceptions of their emotional state and how well the methods and systems disclosed herein assist in identifying and managing their well-being. It will be appreciated that in the method disclosed herein, unconscious emotional states can be joined with conscious emotional states to provide the user with a holistic understanding of their well-being.

It will be appreciated that systems and methods according to certain embodiments of the present disclosure may include, incorporate, or otherwise comprise properties or features (e.g., components, members, elements, parts, and/or portions) described in other embodiments. Accordingly, the various features of certain embodiments can be compatible with, combined with, included in, and/or incorporated into other embodiments of the present disclosure. Thus, disclosure of certain features relative to a specific embodiment of the present disclosure should not be construed as limiting application or inclusion of said features to the specific embodiment unless so stated. Rather, it will be appreciated that other embodiments can also include said features, members, elements, parts, and/or portions without necessarily departing from the scope of the present disclosure.

Moreover, unless a feature is described as requiring another feature in combination therewith, any feature herein may be combined with any other feature of a same or different embodiment disclosed herein. Furthermore, various well-known aspects of illustrative systems, methods, apparatus, and the like are not described herein in particular detail in order to avoid obscuring aspects of the example embodiments. Such aspects are, however, also contemplated herein.

Exemplary embodiments are described above. No element, act, or instruction used in this description should be construed as important, necessary, critical, or essential unless explicitly described as such. Although only a few of the exemplary embodiments have been described in detail herein, those skilled in the art will readily appreciate that many modifications are possible in these exemplary embodiments without materially departing from the novel teachings and advantages herein. Accordingly, all such modifications are intended to be included within the scope of this invention.

What is claimed is:

1. A method for determining a user's emotions and increasing the user's emotional intelligence and self-awareness, comprising:
recording an audio file on a user device of the user's voice engaging in a predetermined task;
transferring the audio file from the user device to an audio processing platform via an application programming interface;
extracting emotional markers from the audio file;
predicting the user's emotional states from the emotional markers; and
recommending one or more actions or prescriptions to the user based on the user's emotional states.

2. The method of claim 1, wherein the predetermined task comprises counting out loud.

3. The method of claim 1, further comprising administering an onboarding survey to solicit user specific information comprising age, gender, and location.

4. The method of claim 1, further comprising administering an emotional state survey to solicit emotional self-assessments data on the user's conscious emotional states.

5. The method of claim 1, further comprising creating audio arrays based on combinations of spectral features extracted from the audio file.

6. The method of claim 1, wherein the emotional markers are transformed into binary states.

7. A method for determining a user's emotions and increasing the user's emotional intelligence and self-awareness, comprising:
providing journaling entries via an app in response to survey prompts;
analyzing the journaling entries using natural language processing;
extracting topical patterns from the journaling entries;
generating emotional likelihoods for the user's emotional states; and
transforming the emotional likelihoods of the user into standardized forms of emotional scores predictive of the user's emotional states.

8. The method of claim 7, further comprising recommending one or more actions or prescriptions to the user based on the user's emotional states.

9. The method of claim 7, further comprising tracking the standardized forms of the emotional scores on the app sequentially across time.

10. The method of claim 7, further comprising generating measurement signal amplifiers including weighting coefficients from the topical patterns.

11. The method of claim 7, further comprising modifying predictive algorithms based on the measurement signal amplifiers.

12. A method for determining a user's emotions and increasing the user's emotional intelligence and self-awareness, comprising:
recording an audio file on a user device of the user's voice engaging in a predetermined task;
transferring the audio file from the user device to an audio processing platform via an application programming interface;
extracting emotional markers from the audio file;
providing journaling entries via an app in response to survey prompts;
analyzing the journaling entries using natural language processing;
extracting topical patterns from the journaling entries;
generating an emotional state report extrapolated from the emotional markers; and
recommending one or more actions or prescriptions to the user based on the user's emotional states.

13. The method of claim 12, wherein the predetermined task comprises counting out loud.

14. The method of claim 12, further comprising administering an onboarding survey to solicit user specific information comprising age, gender, and location.

15. The method of claim 12, further comprising administering an emotional state survey to solicit emotional self-assessments data on the user's conscious emotional states.

16. The method of claim 12, further comprising creating audio arrays based on combinations of spectral features extracted from the audio file.

17. The method of claim 12, wherein the emotional markers are transformed into binary states.

18. The method of claim 12, further comprising personalizing the one or more actions or prescriptions based on the user's cohort.

19. The method of claim 12, further comprising generating measurement signal amplifiers including weighting coefficients from the topical patterns.

20. The method of claim 12, further comprising modifying predictive algorithms based on the measurement signal amplifiers.
